(19) United States
(12) Patent Application Publication
(10) Pub. No.: US 2011/0138920 A1
(43) Pub. Date: Jun. 16, 2011

(54) Contact-free pipe wall thickness measurement device and pipe wall thickness measurement

(75) Inventors: Martin Sauerland, Moenchengladbach (DE); Hans-Joachim Pehle, Moenchengladbach (DE); Mark Haverkamp, Moenchengladbach (DE)

(73) Assignee: SMS Meer GmbH, Moenchengladbach (DE)

(21) Appl. No.: 12/928,042

(22) Filed: Dec. 2, 2010

(30) Foreign Application Priority Data
Dec. 4, 2009 (DE) 10 2009 056 742.9
Feb. 24, 2010 (DE) 10 2010 009 189.8
Jun. 25, 2010 (DE) 10 2010 025 144.5

(51) Int. Cl. G01B 17/02

(52) U.S. Cl. 73/627

(57) ABSTRACT

In order to make available a contact-free pipe wall thickness measurement device having a simple design, having at least two laser ultrasound measurement heads, it is possible to dispose at least two ultrasound measurement heads on a common pivot frame in the contact-free pipe wall thickness measurement device, which frame can pivot about a pivot axis.

### CROSS REFERENCE TO RELATED APPLICATIONS

Applicants claim priority under 35 U.S.C. §119 of German Application No. 10 2009 056 742.9 filed Dec. 4, 2009; German Application No. 10 2010 009 189.8 filed Feb. 24, 2010; and German Application No. 10 2010 025 144.5 filed Jun. 25, 2010, the disclosures of which are incorporated by reference.

The invention relates to a contact-free pipe wall thickness measurement device, as well as to a contact-free pipe wall thickness measurement, in which the wall thickness of the pipe is particularly measured by means of ablatively excited ultrasound.

Such contact-free pipe wall thickness measurement devices or pipe wall thickness measurements are sufficiently known, for example, from EP 1 102 033 A2, in which multiple laser ultrasound measurement heads can also be jointly pivoted about a pipe, whereby the pivoting measurement heads are disposed to be individually adjustable in different angle positions, so that an operator or machine operator adjusts the angle position of the scanners, during ongoing operation, in deviation from a normal position in which measurements can be made at normal resolution, in such a manner that the measurement raster is concentrated over a specific length of the pipe, and therefore, it is practically possible to display the pipe section in an enlargement. In this way, it is possible to increase the resolution capacity in the circumference direction.

Proceeding from this state of the art, the task of the present invention consists in providing a contact-free pipe wall thickness measurement device that has a simple design structure, in which the wall thickness of the pipe is measured by means of ablatively excited ultrasound.

This task is accomplished by means of a contact-free pipe wall thickness measurement device having at least two ultrasound measurement heads, in which the wall thickness of the pipe is measured by means of ablatively excited ultrasound, which is characterized in that the two ultrasound measurement heads are disposed on a common pivot frame, which can pivot about a pivot axis.

The common pivot frame allows a significantly simpler design structure, on the one hand, since the pivoting movement of the measurement heads does not have to be synchronized by way of corresponding controls. Furthermore, merely one common drive is sufficient for the pivoting movement, which generally does not have to take place at overly great speed, if the pipe wall thickness measurement device is otherwise structured in suitable manner.

Depending on the concrete implementation of the present invention, it is possible that the pivot frame performs a rotational movement about a pipe to be measured, rather than a pivoting movement. Since there are limitations, in this connection, particularly for optical conductors, or also further measures have to be provided, it can also be advantageous to go around the pipe to be measured multiple times, and then to change direction after multiple circular movements. In this connection, the number of revolutions would be dependent on the line length that can be laid around the work piece.

In particular, the term “pivoting” in the present connection refers to a rotational movement at moderate speed, which changes its direction of rotation, under some circumstances.

Waiving the possibility of increasing the resolution capacity in the circumference direction, for now, a stable pivoting process can be guaranteed by the common pivot frame, in structurally simple manner.

Using the laser ultrasound wall thickness measurement method, the classical principle of ultrasound running time measurement is applied. At a known speed of sound, the desired wall thickness is obtained from the time required for the ultrasound pulse to pass through the pipe wall. By means of the use of optical methods both for exciting and for detecting the ultrasound pulses, it is possible to dispose the measurement heads themselves at a thermally safe distance from the goods to be measured, so that even a hot wall thickness measurement at temperatures on the order of 1000° C. can be carried out. For excitation, for example, high-energy light pulses in the infrared range are produced, sent to the surface by a diode-pumped or flash-pumped laser that is directed at the goods to be measured, i.e. the pipe, and absorbed there, for the most part leading to evaporation of an extremely thin surface layer. In this connection, the laser light is emitted onto the surface at a frequency of 50 Hz or more, for example, preferably at approximately 100 Hz. In this way, proceeding from the pipe surface, an ultrasound pulse that runs into the pipe wall perpendicular to the pipe surface is formed. The ultrasound pulse that has been formed in this way is reflected at the inner pipe surface, runs back to the outer surface, is reflected again, etc., so that an ultrasound echo sequence with decreasing amplitude is formed in the pipe.

In this connection, it is understood that in place of ablation by means of laser light, a corresponding ablation that excites an ultrasound can also be produced in different manner. For example, this can take place by means of magnetic energy or by means of other electromagnetic effects. Also, irradiation with neutrons or protons is possible. In this regard, ablative excitation of ultrasound is understood to be any excitation of ultrasound in a work piece during which a thin surface layer is removed, at least in part.

The reflected ultrasound pulse produces vibrations on the outer surface of the pipe, which in turn can be detected, in contact-free manner, using a second laser working in continuous light mode, utilizing the Doppler effect. The ultrasound vibration, which is low in comparison with the light frequency, leads to frequency modulation of the light reflected at the material surface. This reflected light and/or the reflected light cone are thus the carrier of the ultrasound signal, and are passed, by way of a light-intense collection lens and a light wave guide, to an optical demodulator, for example a confocal Fabry-Perot interferometer, the output signal of which then already contains the ultrasound echo sequence. The signal can be further amplified, filtered, and evaluated, in known manner, whereby in the final analysis, wall thickness values can be obtained as an output signal, which values are processed further in a computer that is part of the system, and can particularly be used to control an upstream rolling mill.

It is directly comprehensible that in place of detection of the ultrasound using laser light or interference, every other possibility of a corresponding ultrasound measurement, by way of which a running time signal can be obtained, can be used.

In this connection, it is understood that in the final analysis, the double wall thickness is determined by the running time signal, due to the reflection on the inner pipe wall.

By means of the pivoting process as described, the measurement heads can be moved in circular shape around a pipe, so that the quality of a pipe, for example of a seamless steel pipe, which is usually produced in three forming stages, piercing in a skew-rolling mill, stretching in an Assel, Konti, or other rolling mill, and finishing in a dimensional rolling mill or stretch reduction rolling mill, can be checked. In this connection, the number of measurement heads is preferably guided by the type of rolling mills used, as well as by the symmetries predetermined by the roller arrangements and the arrangements of other modules that act on the work piece. In this manner, regions that are particularly susceptible to defects can be subjected to targeted inspection.

Preferably, pivoting takes place by fractions of 360° that correspond to the number of measurement heads. In the case of two measurement heads, pivoting therefore preferably takes place by about 180°, in the case of three measurement heads, pivoting preferably takes place by about 120°, and in the case of four measurement heads, pivoting takes place by about 90°, etc. Proceeding from a rest position, there are therefore pivot angles of ±90° in the case of two measurement heads, ±60° in the case of three measurement heads, and ±45° in the case of four measurement heads. In this regard, the pivot angles are generally calculated in accordance with the number n of measurement heads, according to: pivot angle=±360°/2n. It is understood, in this connection, that depending on the concrete implementation of the present invention, an overlap of the pivot paths of the adjacent measurement heads, in each instance, can take place. Likewise, it is possible that depending on the work piece to be measured, specific regions of the work piece are not detected.

As was already explained initially, significantly greater pivot angles are also possible, whereby in such cases, a rotation about several revolutions can be particularly advantageous. In this connection, the measurement regions overlap accordingly, and can be complemented to produce a complete image, whereby there is the particular advantage that the direction of rotation does not have to be changed so frequently.

On the other hand, it is also possible to provide smaller pivot angles, particularly if defects are expected only at specific locations.

On the other hand, the forces that occur during a reversal of direction are relatively great, so that unnecessarily large units would be necessary, particularly in the case of small pivot movements.

For this reason, in particular, it is advantageous if at least one of the ultrasound measurement heads is disposed on the pivot frame in movable manner. For smaller movements, the ultrasound head that is movably disposed on the pivot frame can then be moved separately, for which purpose significantly lesser masses have to be put into motion, so that on the one hand, small units can be used, and on the other hand, higher frequencies can be achieved. In particular, it is also possible to adapt the measurement heads to locally determined differences.

Thus, it is particularly possible to dispose the ultrasound measurement head on the pivot frame so as to be movable radially relative to the pivot axis. In this way, an eccentric position of the pipe to be measured, with reference to the pivot axis, can be locally equalized, for example. In this way, it is possible to guide the ultrasound measurement head, in each instance, at a constant distance from the work piece to be measured, particularly in the case of an eccentric position. This particularly makes it possible for the ultrasound measurement head to be optimally directed at the work pieces at all measurement times. This particularly relates to its distance.

Mobility directed radially relative to the pivot axis can furthermore be utilized in order to quickly adapt the contact-free pipe wall thickness measurement device to different pipe diameters.

Cumulatively or alternatively to this, the ultrasound measurement head can be disposed on the pivot frame so as to be movable about a nodding axis that deviates from the pivot axis. In this manner, the ultrasound measurement head can perform a nodding movement, which by its nature can also be at a higher frequency, since the measurement head alone has a significantly lesser mass than all the measurement heads together with the pivot frame.

In particular, the nodding axis can be disposed parallel to the pivot axis, which on the one hand ensures a particularly simple structure and simple adjustment.

In this connection, it is understood that—depending on the concrete gear mechanism arrangement between ultrasound measurement head and pivot frame, or depending on the configuration of the mounting of the ultrasound measurement head on the pivot frame, in each instance—the nodding axis can lie on or in the vicinity of the pivot axis. Likewise, it can be at a distance from it, in order to be able to equalize an eccentric position of the work piece, in each instance, for example, whereby for this purpose, the nodding axis can preferably be disposed outside of a transport region of a work piece through the pipe wall thickness measurement device. The latter is particularly possible if the nodding axis, together with the ultrasound measurement head, is disposed on the pivot frame so as to be radially displaceable. In this manner, it can be guaranteed that the nodding movement follows the surface of the work piece to be measured, to the greatest possible extent. On the other hand—depending on the desired angle resolution—it can also be sufficient if the nodding axis is clearly spaced apart from the work piece, since the nodding movement is planned to have only small amplitudes, in any case.

In particular, it is also possible that the nodding axis is disposed inclined with reference to the pivot axis. It can particularly also be provided perpendicular to the latter. In the case of the latter orientation, in particular, the measurement head can perform a circular movement, which, in the final analysis, then also leads to a corresponding curve path of the region measured on the pipe wall, so that it is possible to entirely do without changes in direction during nodding. This is extremely gentle on the material and advantageous in terms of energy. Depending on the concrete orientation of the nodding axis and of the measurement head with reference to the nodding axis, more complex movement sequences can also be implemented, as long as it is ensured that the measured region on the pipe wall migrates in corresponding manner.

In accordance with the embodiment presented above, a contact-free pipe wall thickness measurement is therefore also proposed, which is characterized in that the pivot frame is moved about the pivot axis at a pivot frequency, and at least one of the measurement heads is moved about the nodding axis at a nodding frequency, whereby the pivot frequency is less than the nodding frequency. Likewise, a contact-free pipe wall thickness measurement is proposed, which is characterized in that the pivot frame is moved about a pivot axis, and at least one of the measurement heads is moved about the nodding axis, whereby the mass moved during the movement about the nodding axis is smaller than the mass moved during the movement about the pivot axis. Such method management allows precise inspection of the entire work piece circumference by means of the pivoting movements, on the one hand, while the nodding movement can serve for detailed review of regions that are particularly susceptible to defects, for example.

Preferably, the nodding speed or frequency is at least three times as great as the pivot speed or frequency. At such speed or frequency ratios, the different measurement procedures can be utilized and used in particularly optimal manner.

Accordingly, it is furthermore advantageous if the amplitude of the nodding movement is at least half as great as the amplitude of the pivoting movement.

It is understood that the pivoting movement and the nodding movement do not necessarily have to be performed at the same time.

Since it cannot be precluded that the work piece to be measured runs through the contact-free pipe wall thickness measurement device eccentric to the pivot axis of the pivot frame, it is advantageous if the contact-free pipe wall thickness measurement device has means for determining the radial work piece position. In this connection, it should be pointed out that the term “radial” is directed at-directions and assignments oriented perpendicular to the movement direction of the pipe through the pipe wall thickness measurement device. Depending on the radial work piece position, the ultrasound measurement heads can then be oriented radially in such a manner that they have the most optimal distance from the surface of the work piece to be measured. Such a distance optimization is particularly advantageous if the optical light paths do not all run in collinear manner, or if optical modules that have a focusing effect are used, since it can be guaranteed in this manner that the inclined optical measurement beams or the focused beams remain positioned in the most optimal manner.

All devices that make it possible to determine the position of a work piece in the region of the contact-free pipe wall thickness measurement can be used as position measurement means. A conclusion can be drawn, concerning the location of the outer pipe mantle surface, from the position, if necessary by taking the known pipe diameter into consideration.

In particular, distance sensors can also be provided as position measurement means, which directly measure the distance between a known module, for example a fixed rack or frame, but also the pivot frame or the ultrasound measurement heads, and the work piece surface, in other words the outer pipe mantle surface. By means of this distance measurement, in the final analysis, a conclusion can be drawn concerning the position of the pipe as a whole, if this is actually desired. On the other hand, this distance measurement yields the location of the outer pipe mantle surface or the outer wall of the pipe, and in the final analysis, this represents a suitable measurement variable particularly for radial control of the ultrasound measurement heads.

Accordingly, the task of the present invention is also accomplished by a contact-free pipe wall thickness measurement device that is characterized by a device for measuring the pipe surface. In particular, known distance sensors can be provided as a pipe surface measurement device, particularly if these can be pivoted above the surface, for example, and can measure over a surface segment in this manner. Likewise, distance sensors that can detect an entire surface segment even without a pivoting procedure can also be used. By means of such pipe surface measurement devices, it is particularly possible to determine dents and/or tears, which by their nature are very difficult or impossible to detect by means of a pipe wall thickness measurement.

Preferably, the distance sensors are disposed in such a manner that they can determine the distance of the outer pipe wall from the ultrasound measurement heads at the level of the ultrasound measurement, in order to be able to fulfill the measurement task explained above in particularly advantageous manner. In this connection, it is understood that smaller deviations with regard to the essentially known pipe geometries are not critical in this regard, as long as the desired tolerance ranges are not departed from.

In particular, the distance sensors can be disposed on the ultrasound measurement heads, for example. This facilitates assignment of a distance measurement or of a corresponding measurement signal to the corresponding ultrasound measurement head. On the other hand, a corresponding distance sensor can also be provided on the pivot frame described above.

Known light section sensors have proven to be particularly suitable distance sensors; they can be used to scan and detect a surface region in a specific angle segment. In this connection, light section sensors are able, for example, to spatially cover an angle range of 110°—in other words almost a third of a circle. In this regard, the complete circle surface of the outer wall of a pipe to be measured can be measured by means of four light section sensors. When only three light section sensors are used, smaller regions that cannot be measured without a pivoting movement remain, but if the light section sensors are placed appropriately, these regions can be provided in spatial positions that are insignificant for the measurement result. It is understood that just as suitable light section sensors are commercially available, corresponding light section sensors having greater detection angles can also be used. Accordingly, such light section sensors can also be used as a pipe surface measurement device, whereby it is understood that this can also take place in combination with a distance measurement.

In particular, a corresponding distance sensor, preferably a light section sensor, can be provided on at least one of the ultrasound measurement heads. In this manner, the relevant distance for this ultrasound measurement head can be determined independent of the location of the ultrasound measurement head. In connection with the pipe wall thickness measurement, it is therefore possible to locally measure not just the pipe wall thickness but also the roundness or the precise configuration of the pipe cross-section, accordingly. Furthermore, by means of the placement of the distance sensor directly on the ultrasound measurement head, it is possible, in terms of design, to provide a control circuit for radial placement of the ultrasound measurement head with reference to the outer wall of the pipe to be measured. In the end result, it can be sufficient to configure this control circuit in such a manner that the distance is kept constant, and to use the radial position of the ultrasound measurement head as a measure of the position of the outer wall of the pipe to be measured. By means of a pivoting movement or nodding movement of the ultrasound measurement head, the detection range of the distance sensor, and, in particular, of the light sensor is furthermore expanded accordingly.

As was already indicated initially, such contact-free pipe wall thickness measurements must be carried out particularly on relatively hot pipes, which can have temperatures far above 800° C., particularly also up to 1200° C. and above. In this connection, temperature variations can occur, which can also influence the speed of sound in the pipe and therefore the measurement result of the pipe wall thickness measurement, if applicable. In order to be able to counter possible measurement errors, it is advantageous if the contact-free pipe wall thickness measurement device has a temperature sensor. In particular, such a temperature sensor can also be disposed on at least one of the ultrasound measurement heads, and can determine the temperature in the surroundings or at the actual measurement location. In this manner, it can be assured, in structurally simple manner, that the temperature is measured at the location that is significant for the measurement result. Furthermore, the placement on the ultrasound measurement head also has the advantage that units that are present there, in any case, such as a cooling system, for example, can also be used for the temperature sensor. Of course, the latter also holds true for the distance sensor that is provided on the ultrasound measurement heads.

A particularly simple and compact configuration is obtained if the pivot frame encompasses the pivot axis, and a relatively compact method of construction can be guaranteed in this manner. As the result of the encompassing, a clear space provided radially within the pivot frame follows directly, through which a work piece or pipe to be measured can be passed. Preferably, such encompassing can be guaranteed by means of an essentially circular basic structure of the pivot frame.

In order to facilitate maintenance work, the pivot frame can have an accident slit that makes it possible to displace the pivot frame out of its measurement position even if a pipe can be found in the region of the pivot axis or in the encompassed space of the pivot frame. In this manner, corresponding maintenance work can be facilitated, on the one hand. On the other hand, the pipe wall thickness measurement device is protected, since the hot pipe, which, in the event of an accident, could possibly come to rest in the direct vicinity of the pivot frame or also in the vicinity of the ultrasound measurement heads, at temperatures of 800° C. and higher, subjects these modules to significant heat stress. This particularly holds true if any movements of the pipe wall thickness measurement device itself have to be adjusted for maintenance work. In this regard, it is understood that such an accident slit in a pivot frame is advantageous for the reasons indicated above, for pipe measurement devices of all kinds for pipes that are measured at temperatures above 800° C., even independent of the other characteristics of the present invention.

Accordingly, it is advantageous if the pivot frame can be displaced from a measurement position into a maintenance position perpendicular to the pivot axis. For this purpose, it can be disposed on a corresponding support frame, for example, which allows the rotational movement of the pivot frame as described above and in turn can be displaced from a measurement position into a maintenance position. Such a displacement of the support frame preferably takes place horizontally. Furthermore, it is understood that the pivot frame can also be displaceable vertically relative to the support frame, for example for additional adjustments when the pipe diameter is changed or also for maintenance work or other purposes.

While it might be sufficient for the pivot frame to be able to pivot only by smaller angle ranges such as by ±60° or ±45°, in order to be able to fulfill its measurement tasks, it is advantageous if the pivot frame can be pivoted, at least in the maintenance position, in such a manner that each of the measurement heads can be displaced into a horizontal position for maintenance purposes. This means that in the case of three measurement heads, preferably a pivoting possibility of at lest 90° in one direction should be provided, if one of the measurement heads is disposed vertically in its central measurement position. The same holds true for pipe wall thickness measurement devices in which four measurement heads are provided and at least one of the measurement heads is disposed vertically. If, on the other hand, none of the measurement heads is disposed vertically in its central position, then lesser pivoting possibilities can be sufficient for maintenance purposes, accordingly.

The advantage of a horizontal maintenance position for the ultrasound measurement heads is that all the modules can be easily reached and, in the final analysis, a predetermined and similar position of all the modules can be made available for the maintenance personnel.

The pipe wall thickness measurement device can comprise a testing device that comprises a test specimen that can be displaced from a rest position into a test position, whereby the test specimen therefore lies essentially on the pivot axis in the test position, in the measurement region of the ultrasound measurement heads, if the frame is disposed in its maintenance position. It is understood that such a test specimen is advantageous even independent of the other characteristics of the present invention, particularly also independent of the presence of a separate maintenance position, in order to calibrate or adjust such a measurement device in fast and operationally reliable manner, or also to check it with regard to its function.

In this connection, the testing procedure can serve for calibration purposes or adjustment purposes, but also for a check of function.

Preferably, the test specimen can be rotated in its testing position, in order to provide different measurement constellations in this manner. Likewise, the test specimen can be axially displaceable, in order to be able to represent different measurement situations accordingly. Furthermore, the test specimen can have defects or deviations that must be detected with the desired accuracy during the test. If necessary, the testing device can have a heating system to adapt the test specimen to the work pieces that are to be measured, also with regard to temperature.

The present invention is particularly suitable for heating pipes, as for pipes with a temperature of above 750° C., such as they occur in hot rolling mills, for example. Particularly at such temperatures, very great stress on the measurement heads must be expected. Furthermore, it is understood that the present invention is not restricted just to pipes in the narrower sense, and can be used, for example, also for measuring wall thicknesses of hollow blocks, sleeves, balls or fore pipes. In this regard, the term “pipe” in the present connection refers to any work piece that has a longitudinal expanse direction and at least one central opening that extends longitudinally.

It is understood that the characteristics of the solutions described above and/or in the claims can also be combined, if applicable, in order to be able to implement the advantages in correspondingly cumulative manner.

Further advantages, aims, and properties of the present invention will be explained using the following description of the attached drawing. In the drawing, the figures show:

FIG. 1 a front view of a pipe wall thickness measurement device according to the invention;

FIG. 2 a schematic front representation of the measurement beams of the laser ultrasound measurement heads of the pipe wall thickness measurement device according to FIG. 1, with reference to a roller arrangement;

FIG. 3 a schematic representation of the types of movement of the laser ultrasound measurement heads;

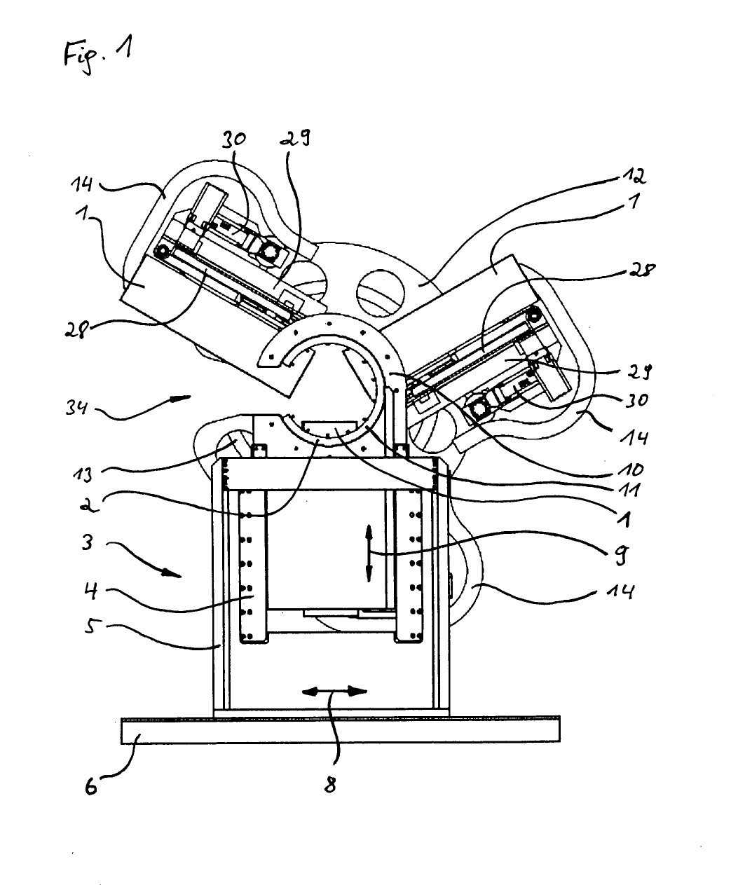

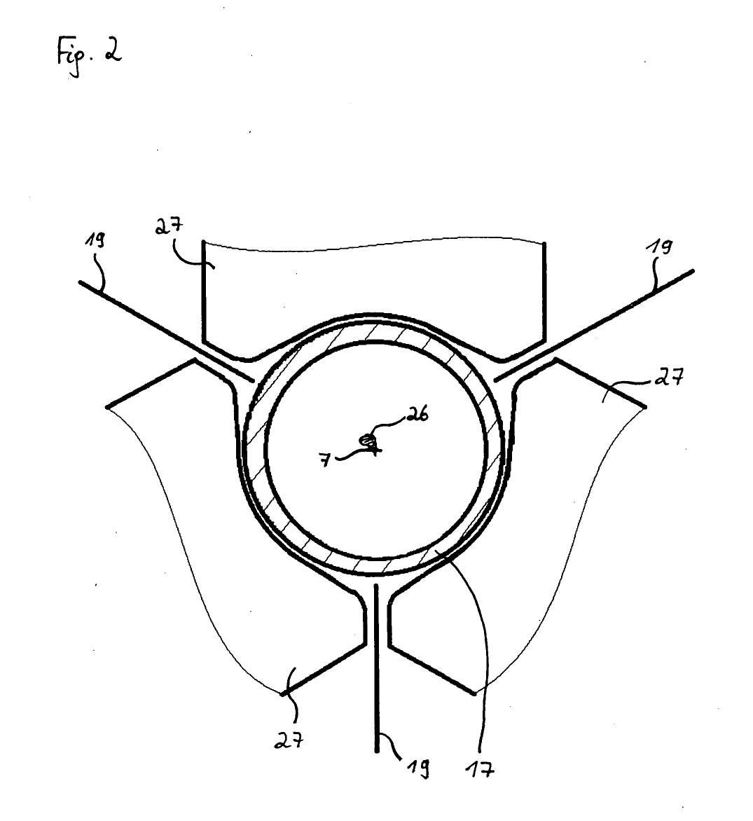

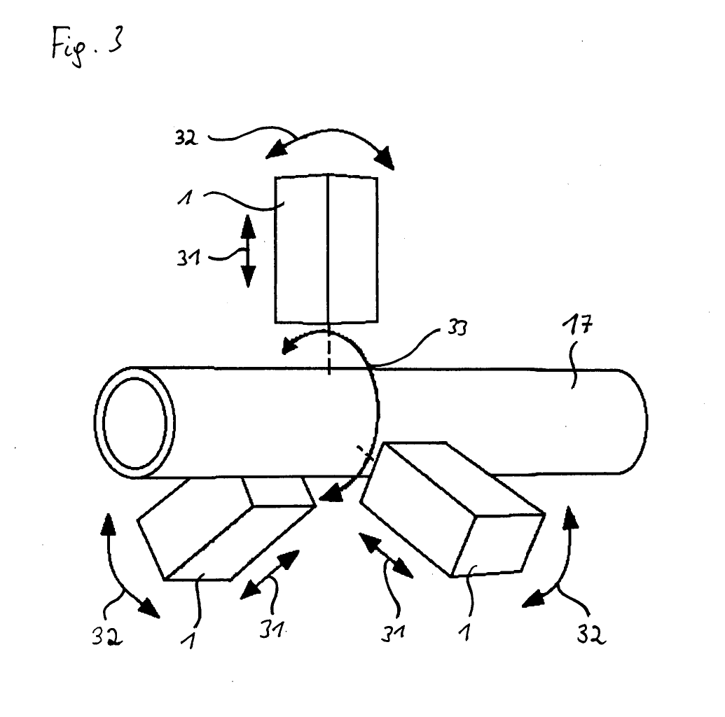

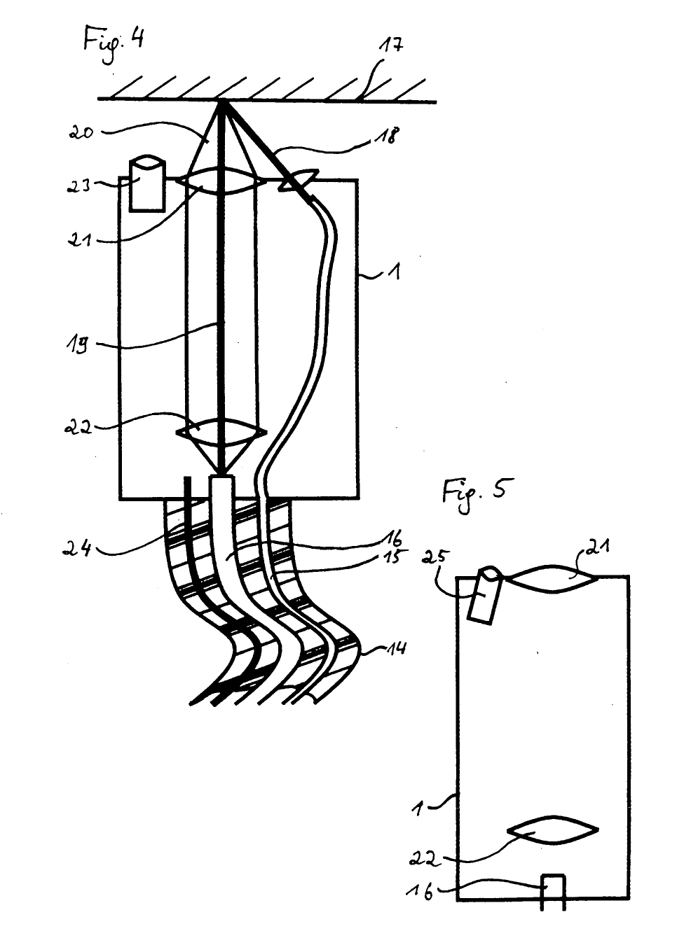

FIG. 4 a schematic section through a laser ultrasound measurement head;

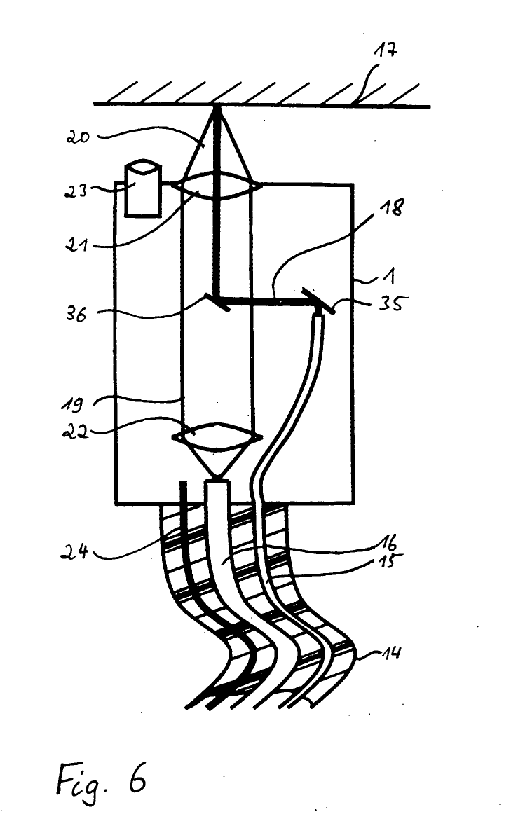

FIG. 5 a schematic section through the laser ultrasound measurement head according to FIG. 4 in a representation perpendicular to the representation according to FIG. 4; and

FIG. 6 a schematic section through another laser ultrasound measurement head in a similar representation as that of FIG. 4.

The pipe wall thickness measurement device according to FIG. 1 has three laser ultrasound measurement heads 1 that are movably disposed on a pivot frame 2 at an angle of 120° relative to one another.

The pivot frame 2 is disposed on a support frame 3 so as to rotate or pivot about a pivot axis 7 (see, in particular, FIG. 2); this frame in turn comprises a lift table 4, a carriage 5, and a floor plate 6. In this connection, the carriage 5 can be displaced horizontally, perpendicular to the pivot axis 7 (see double arrow 8), while the lift table 4 is mounted so that it can be vertically set against the carriage 5 (see double arrow 9). In this manner, the pivot frame 2 and therefore the laser ultrasound measurement heads 1 can be displaced relative to the pivot axis 7, so that the pivot axis 7 can be offset parallel, accordingly.

This parallel offset makes it possible to adapt the position of the laser ultrasound measurement heads 1 to different pipe diameters, and to move them into different positions for maintenance purposes.

The upper region of the lift table 4 has a rotating bearing 10, in which a corresponding rotating bearing 11 of the pivot frame 2 moves in rotating manner. Furthermore—depending on the concrete configuration of this exemplary embodiment—measurement devices as well as cleaning devices, such as cleaning glands or the like, are also provided on the lift table 4.

The pivot frame 2 furthermore has a pivot plate 12 that carries the laser ultrasound measurement heads 1, on the one hand, and a drive gear wheel 13, on the other hand. In the case of this exemplary embodiment, the drive gear wheel 13 has teeth on its inside, into which a rack (not shown) of a drive motor (not shown) engages accordingly, in order to control the pivoting movement in the desired manner. On the outer edge of the gear wheel 13, a contact surface for a supply line (not shown) is furthermore provided, which line brings in and carries away required operating media, such as cooling water, electricity, optical lines, or others, which will still be explained in detail below.

From the supply line, not shown, individual supply lines 14, in each instance, go to the laser ultrasound measurement heads 1, in each instance. In the supply lines 14, as is indicated as an example in FIG. 4, two optical light guides 15, 16, in particular, as well as cooling water lines and electrical current supply (the latter two not shown) are provided, in order to be able to operate the laser ultrasound measurement heads 1 in known manner. For this purpose, a laser beam 18 directed at a slant is radiated, in pulsed manner, onto the surface of a pipe 17, by way of optics 21 and a light guide 15. The ultrasound vibrations brought about in this manner—and particularly their reflections—can then be measured by way of an also known optical measurement device, whereby the pipe wall thickness can be determined from the running time of the ultrasound pulses. For this purpose, a laser beam 19 is radiated onto the surface of the pipe 17 and the reflection cone 20 is detected by optics 21. While this method of procedure is fundamentally known from the state of the art, the latter measurement procedure takes place in confocal manner in this exemplary embodiment, so that the laser beam 19 is guided onto the pipe 17 by means of the same optics 21 by means of which the reflection cone 20 is also detected. This makes it possible to couple both the laser beam 19 and the reflected light of the reflection cone 20 into and out of the light guide 16 together, by way of a common collimator 22, which can, however, also be eliminated, if necessary, depending on the suitable optics 21.

Furthermore, in this exemplary embodiment, the optical axis of the optics 21 is directed perpendicular to the surface of the pipe 17, so that slight deviations in the distance with regard to this measurement, in which, in the final analysis, the Doppler shift that occurs as the result of the ultrasound vibrations in the reflection cone 20, is measured, are not quite so critical. Furthermore, with this arrangement, the reflection cone 20 can be detected as optimally as possible. On the other hand, it is understood that because of the slanted position of the laser beam 18, the distance between laser ultrasound measurement head 1 and pipe 17 can vary only within narrow limits, without having an overly strong negative influence on the measurement result.

In the case of the exemplary embodiment according to FIG. 6, the latter set of problems is eliminated in that the laser beam 18, which has an ablative effect, is also guided confocally by means of the optics 21, in that it is coupled onto the optical axis, into the beam path consisting of laser beam 19 and reflection cone 20, by way of two mirrors 35, 36. In this connection, the laser beam 19 used for measuring the ultrasound is widened by the collimator 22, and focused accordingly by the optics 21, so that the excitation light of the laser beam 19 used for the measurement passes through the same optical path as the reflected light of the reflection cone 20, which has been modified by the ultrasound. Because of this widening, the losses caused by the mirror 36 disposed in the beam path of the laser beam 19 and of the reflection cone 20 are minimal.

For the remainder, the exemplary embodiment according to FIG. 6 corresponds to the exemplary embodiment shown in FIGS. 4 and 5, so that accordingly, identical reference numbers are used, and repetition of the technical relationships, which are identical in the two exemplary embodiments, is abstained from.

In place of the mirrors 35, 36, depending on the concrete conditions, semi-permeable mirrors or prisms can also be used. In this way, the stability of the optical path or the light yield can be improved, for example, in that total reflections are used at material transitions for deflecting the light beams or in that the different frequencies of the laser beams 18, 19 and their different interaction with the materials of a semi-permeable mirror that has been selected accordingly are utilized, for example.

The relatively great closeness of the laser ultrasound measurement head 1 to the pipe 17 brings about the result that this head must be cooled in suitable and known manner. This does not have to be discussed further, since this is sufficiently known from the state of the art.

The laser ultrasound measurement head 1 of both exemplary embodiments furthermore comprises a light section sensor 23, by means of which, on the one hand, the distance of the laser ultrasound measurement head 1 from the surface of the pipe 17 can be measured and used for distance control. On the other hand, a surface image of the surface of the pipe 17 can be obtained by means of the light section sensor 23, at an angle of about 100° to 110° perpendicular to the pipe axis 26, so that a statement about the overall quality of the pipe can be made by means of this information and the measurement result with regard to the pipe wall thickness.

Disposed behind the optics 21, in FIG. 4, the laser ultrasound measurement heads 1 furthermore also have a temperature sensor 25, which is also disposed in the laser ultrasound measurement head 1 at a slight incline, and measures the temperature of the pipe 17 in the region in which the laser beam 19 hits the pipe 17. In this manner, thermally caused running time variations in the ultrasound can be taken into consideration in the pipe wall thickness measurements. It is understood that if necessary, the beam path of the temperature sensor 25 and/or the beam path of the light section sensor 23 can also be guided by the optics 21, in collinear manner.

The measurement results of the light section sensor 23 or of the temperature sensor 25, in each instance, are also passed out of the measurement head by way of data lines 24.

As is particularly indicated in FIG. 2, it is true that the pivot axis 7 is clearly defined geometrically by the geometry of the rotating bearings 10, 11. Unfortunately, this statement cannot be made for the pipe axis 26, since the pipe, by its nature, is subjected to variations during its production process, which can be caused, for example, by corresponding rollers 27 (schematically indicated in FIG. 2). Thus, for example, outside pipe diameter and inside pipe diameter can have different axis center points. Likewise, different local distortions can occur. Frequently, such defects are production-related and can be attributed to the devices used during production. Thus, for example, in the case of a three-roller arrangement of rollers 27, as shown in FIG. 2, third-order disruptions can be expected, which can be found, in particular, in the roller interstices of the rollers 27. If two three-roller arrangements disposed offset relative to one another are used, then accordingly, sixth-order defects can be expected. In accordance with the expected order of defects, it is recommended to dispose the laser ultrasound measurement heads 1 on the pivot frame 2. Likewise, it is recommended to select the number of laser ultrasound measurement heads 1 in accordance with the expected order, whereby as a rule, two, three, or four laser ultrasound measurement heads should be sufficient.

In order to be able to take these deviations into account quickly and in operationally reliable manner, the laser ultrasound measurement heads 1 are connected with the pivot frame 2 by way of a linear drive 28, in each instance, whereby the stator 29 of the linear drive 28 in turn is mounted on the pivot frame 2 so as to move in rotation, for which purpose a linear drive 30 is used, which can set the stator 29 about a rotating joint (not shown), which defines a nodding axis (not shown).

Thus, the laser ultrasound measurement heads 1 can be individually set radially with regard to the pivot axis 7, in each instance, by way of the linear drives 28, as is indicated as an example in FIG. 3, with the double arrows 31. At least during measurement operation, the radial engagement 31 can be regulated directly by way of distance sensors, such as, in particular, the light section sensors 23. In this exemplary embodiment, the lift can amount to 400 mm, for example.

As a result of the linear drives 30 and the rotating joints, not shown, the laser ultrasound measurement heads 1 can furthermore individually perform a nodding movement, in each instance, shown by the double arrows 32 in FIG. 3. This nodding movement can comprise ±15°, for example, in this exemplary embodiment, and runs around the position of the laser beams 19 shown in FIG. 2 at this angle deflection. By means of this nodding movement, detailed images of specific angle regions of the pipe 17 can thus be recorded, in order to obtain a very detailed and precise image of the pipe 17 in these regions. In this way, it is particularly possible to find defects in the positions most likely to have defects. While the nodding axis is disposed radially outside of the rotating bearings 11, at the level of the pivot plate 12, in this exemplary embodiment, it is, however, easily possible to also displace the nodding axis further inward radially, by means of a suitable gear mechanism arrangement or, for example, by means of a lever linkage. The same result can be achieved by means of motion link guides or similar devices.

In this connection, it is directly comprehensible that the nodding movement does not necessarily have to take place about an axis that is oriented essentially parallel to the pipe axis 26 or to the pivot axis 7. Instead, this axis can also be oriented at an incline or essentially perpendicular to the pipe axis 26 or to the pivot axis 7. In the case of the latter orientation, in particular, but also in the case of deviations from this, it is possible to also carry out a circular movement in place of a back-and-forth movement, for example as a nodding movement; this circular movement brings about a corresponding movement of the focus of the measurement head 1 on the pipe surface of the pipe 17.

The laser ultrasound measurement heads 1 can furthermore be pivoted about the pivot axis 7 by ±60°, by means of the rotating bearings 10, 11 of the drive gear wheel 13 as well as the related drive, in order to perform measurements over the entire pipe circumference, as is indicated in FIG. 3 by means of the double arrow 33. In this connection, the laser ultrasound measurement heads 1, in the exemplary embodiment shown in FIG. 1, can furthermore be pivoted counterclockwise (in the viewing direction onto the drawing surface of FIG. 1), by 90°, so that even the laser ultrasound measurement head 1 that points perpendicularly downward can be displaced into a horizontal maintenance position. It is understood that if necessary, greater pivoting movements or even a purely rotational movement can be provided, whereby then, if necessary, structural changes must be made in the rotating bearings 10, 11, on the drive gear wheel 13, and on the pivot plate 12. Also, the supply of the units, in each instance, must then be assured in suitable manner. Significant structural changes would then be, in particular, bridging of the accident gap 34, which is provided, in the present exemplary embodiment, not only in the rotating bearings 10, 11 but also in the drive gear wheel 13 and the pivot plate 12. By means of this accident gap 34, the entire arrangement can be moved horizontally out of the measurement position into the maintenance position, even if a pipe 17 is still situated within the measurement region.

If only because of the different masses that must be moved, in each instance, nodding 32 takes place at a significantly higher frequency or nodding speed than pivoting.

The horizontal displacement 8 and the vertical displacement 9 serve essentially for maintenance purposes, on the one hand, but they can also be utilized for slow adjustment processes, such as those that can occur, for example, if the pipe diameter is changed, when different pipes are supposed to be worked on and measured, or, alternately, in the case of very great but slow bending or curvature of the pipe.

Also, the structural effort with regard to possible work on a foundation can be minimized by means of the vertical displacement 9—depending on the concrete implementation of the present invention. If the corresponding rolling line or a corresponding pipe conveyor in which the pipe wall thickness measurement device is used has a relatively low construction, then it can be necessary to open up a foundation that might be present in the region of the pipe wall thickness measurement device, particularly so that at least one of the laser ultrasound measurement heads 1 can be used even underneath the rolling line or the pipe conveyor. By means of the vertical displacement 9, the laser ultrasound measurement heads 1 can be raised at an early point in time, if necessary at first or already after a short horizontal displacement 8, so that then, further foundation work is not necessary. Possibly, it is advantageous if the accident gap 34 is oriented differently for this purpose, for example partly opened downward, whereby, if necessary, the carriage 5 can also be partly opened accordingly, and provided with an accident gap or with an accident recess. Also, it is possible to enlarge the accident gap 34 accordingly, but this can possibly lead to losses in the guidance performance of the rotating bearing 11. Under some circumstances, this can be countered by means of a suitable insert, which can be removed in the event of an accident, to extend the rotating bearing 11 into the accident gap 34.

It is understood that a pipe wall thickness measurement device having a horizontal displacement 8 and the vertical displacement 9 is advantageous even independent of the other characteristics of the present invention, in order to allows its use even with low rolling lines or pipe conveyors in which the pipe wall thickness measurement device is supposed to be used, with minimal foundation work. This particularly holds true in interplay with an accident gap and its suitable orientation and configuration.

### REFERENCE SYMBOL LIST

1 laser ultrasound measurement head
2 pivot frame
3 support frame
4 lift table
5 carriage
6 floor plate
7 pivot axis
8 horizontal displacement
9 vertical displacement
10 rotating bearing
11 rotating bearing
12 pivot plate
13 drive gear wheel
14 supply line
15 light guide
16 light guide
17 pipe
18 laser beam
19 laser beam
20 reflection cone
21 optics
22 collimator
23 light section sensor
24 data line
25 temperature sensor
26 pipe axis
27 rollers
28 linear drive
29 stator
30 linear drive
31 radial engagement
32 nodding
33 pivoting
34 accident gap
35 mirror
36 mirror

What is claimed is:

1. Contact-free pipe wall thickness measurement device, in which the wall thickness of the pipe is measured by means of ablatively excited ultrasound, wherein at least two ultrasound measurement heads are disposed on a common pivot frame, which can pivot about a pivot axis.

2. Device according to claim 1, wherein at least one of the ultrasound measurement heads is movably disposed on the pivot frame.

3. Device according to claim 2, wherein the ultrasound measurement head is disposed on the pivot frame so as to move radially relative to the pivot axis.

4. Device according to claim 2, wherein the ultrasound measurement head is disposed on the pivot frame so as to move about a nodding axis that deviates from the pivot axis.

5. Device according to claim 4, wherein the pivot axis is disposed parallel to the nodding axis.

6. Device according to claim 5, wherein the nodding axis is disposed outside of a transport region through the pipe wall thickness measurement device.

7. Device according to claim 4, wherein the nodding axis is disposed inclined relative to the pivot axis.

8. Contact-free pipe wall thickness measurement device, in which the wall thickness of the pipe is measured by means of ablatively excited ultrasound, comprising means for determining the radial work piece position.

9. Device according to claim 8, wherein the position determination means comprise at least one distance sensor.

10. Device according to claim 9, wherein the distance sensor is provided on at least one ultrasound measurement head.

11. Contact-free pipe wall thickness measurement device, comprising at least one device for measuring the pipe surface.

12. Device according to claim 11, wherein the pipe surface measurement device comprises a light section sensor.

13. Contact-free pipe wall thickness measurement device, in which the wall thickness of the pipe is measured by means of ablatively excited ultrasound, comprising at least one ultrasound measurement head on which a temperature sensor is provided.

14. Device according to claim 1, wherein the pivot frame encompasses the pivot axis, preferably except for an accident slit.

15. Device according to claim 1, wherein the pivot frame can be displaced from a measurement position into a maintenance position, perpendicular to the pivot axis, particularly horizontally.

16. Device according to claim 15, further comprising a testing device that comprises a test specimen that can be displaced from a rest position into a test position, in which it lies in the measurement range of the ultrasound measurement heads, when the frame is disposed in its maintenance position.

17. Device according to claim 16, wherein the test specimen is connected with the testing device by way of a rotational drive.

18. Contact-free pipe wall thickness measurement device, in which the wall thickness of the pipe is measured by means of ablatively excited ultrasound, wherein at least two ultrasound measurement heads are disposed on a common pivot frame, and wherein the pivot frame is moved about a pivot axis at a pivoting frequency, and at least one of the measurement heads is moved about a nodding axis at a nodding frequency, whereby the pivoting frequency is smaller than the nodding frequency.

19. Contact-free pipe wall thickness measurement device, in which the wall thickness of the pipe is measured by means of ablatively excited ultrasound, wherein at least two ultrasound measurement heads are disposed on a common pivot frame, and wherein the pivot frame is moved about a pivot axis, and at least one of the measurement heads is moved about a nodding axis, whereby the mass moved during the movement about the nodding axis is smaller than the mass moved during the movement about the pivot axis.

20. Measurement according to claim 18, wherein the nodding axis deviates from the pivot axis.

21. Measurement according to claim 18, wherein at least one of the measurement heads is radially displaced during pivoting and/or during nodding.

22. Measurement according to claim 21, wherein the radial displacement takes place as a function of a position of an outer wall of the pipe to be measured.
